(19) United States
(12) Patent Application Publication
(10) Pub. No.: US 2020/0086939 A1
(43) Pub. Date: Mar. 19, 2020

(54) MOTORIZED SCOOTER SYSTEM

(71) Applicant: Grin, Inc., Roma Norte (MX)

(72) Inventor: Luke Iseman, Oakland, CA (US)

(21) Appl. No.: 16/574,868

(22) Filed: Sep. 18, 2019

Related U.S. Application Data
(60) Provisional application No. 62/733,022, filed on Sep. 18, 2018.

(51) Int. Cl. B62H 5/20; B60R 25/102; B60R 25/10

(52) U.S. Cl. CPC B62H 5/20; B60R 25/102; B60R 25/1004; B62J 2099/002; B62K 2204/00; B62K 2207/00; B62K 2202/00

(57) ABSTRACT

A motorized scooter is disclosed that has a computing platform and wireless communications capabilities on board. Some embodiments relate to selecting a wireless communication system for transmitting messages from the motorized scooter. Some embodiments relate to detecting intrusion into a compartment of the scooter and responding to the detected intrusion. Some embodiments relate to detecting theft of the scooter and responding to the detected theft.

### CROSS-REFERENCE TO RELATED APPLICATION

This application claims the benefit of U.S. Provisional Application No. 62/733,022, filed on Sep. 18, 2018, which is hereby incorporated by reference in its entirety.

### FIELD OF INVENTION

This specification generally relates to motorized scooters.

### BACKGROUND

Motorized scooters come in many shapes and configurations, such as being stand-up or sit-down and having various engine sizes. One example of a motorized scooter is a powered stand-up scooter using a small utility gas engine or electric motor. Some scooters may be designed with a large deck in the center on which the operator may stand and an upright support having handlebars for the operator to steer and control the motorized scooter.

### SUMMARY

According to one implementation, this specification describes motorized scooters and systems of motorized scooters. In some embodiments, a motorized scooter includes a computing platform and wireless communications capabilities on board. Wireless communications interfaces may include one or more wireless local area network interfaces, wireless personal area networks interfaces, wireless wide area network interfaces, wireless metropolitan area network interfaces, and/or cellular network interfaces. A scooter may communicate with a remote computing platform via one or more of the on board wireless network interfaces. Embodiments relate to choosing which of the plurality of wireless network interfaces to use for transmitting a message.

In some embodiments, a scooter may also include one or more sensors such as but not limited to light sensors, temperature sensors, force sensors, color sensors, imaging sensors, acoustic or sound sensors, vibration sensors, magnetic sensors, electric current sensors, humidity sensors, position sensors, compasses, acceleration sensors, orientation sensors, or other similar sensors. Sensors may be used to detect intrusion or theft of the scooter. In some embodiments, messages may be tagged or marked with an importance indicator and an optional timeout indicator. Messages may be ranked on a relative scale of importance, such as an integer from 0 to 100, or a more coarse representation such as low priority, medium priority, and high priority. A timeout may be expressed as either a duration of time measured from the controller receiving the message or as a set absolute time by which the message will timeout. A timeout may also be infinite such that the timeout never expires for some messages. In operation, some messages may be tried and retried several times based on retry criteria before the timeout period expires. Some messages may be escalated to a different wireless network interface before the timeout expires. Some messages may be dropped upon timeout expiration, and other messages may be escalated to a different wireless network interface upon timeout expiration.

The details of one or more implementations of the subject matter described in this specification are set forth in the accompanying drawings and the description below. Other potential features, aspects, and advantages of the subject matter will become apparent from the description, the drawings, and the claims.

### BRIEF DESCRIPTION OF THE DRAWINGS

The present disclosure will become more fully understood from the detailed description and the accompanying drawings, wherein:

FIG. 1 illustrates a motorized scooter according to an embodiment;

FIG. 2 illustrates an example wireless communication environment in which some embodiments may operate;

FIG. 3 illustrates the steps of a method of processing a low priority message;

FIG. 4 illustrates the steps of a method of processing a medium priority message;

FIG. 5 illustrates the steps of a method of processing a critical priority message;

FIG. 6 illustrates an example mesh networking environment according to an embodiment;

FIG. 7 illustrates the steps of a method for detecting malicious intrusion according to an embodiment;

FIG. 8 illustrates the steps of a method to module a response to an intrusion or theft according to an embodiment; and

FIG. 9 illustrates an example machine of a computer system within which a set of instructions, for causing the machine to perform any one or more of the methodologies discussed herein, may be executed.

### DETAILED DESCRIPTION

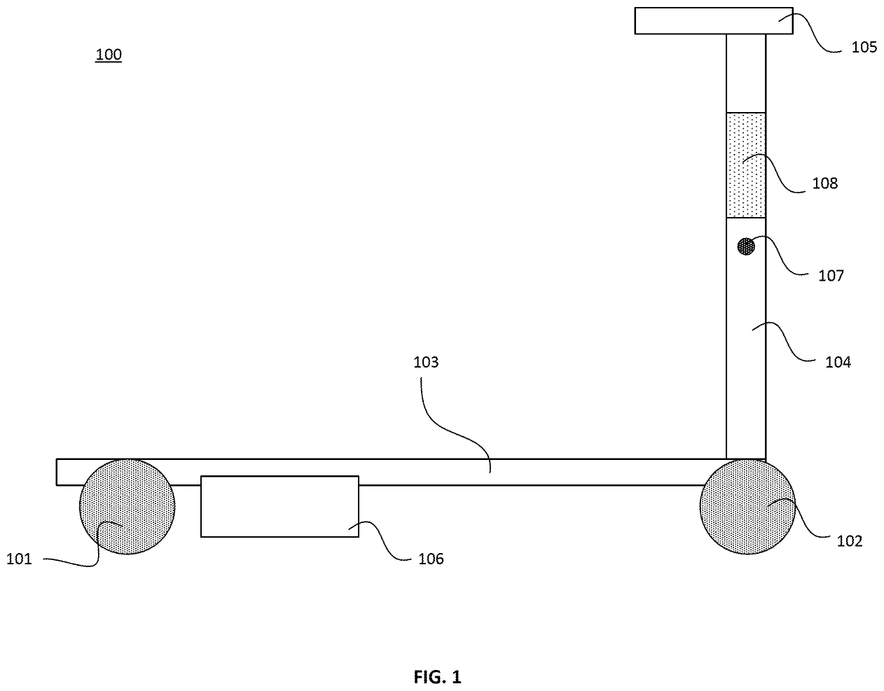

FIG. 1 illustrates a motorized scooter 100 according to an embodiment. Exemplary motorized scooter 100 has two wheels 101 and 102, a deck 103, and an upright support 104 having handlebars 105 attached on top. An operator may stand on deck 103 and grasp handlebars 105 to control steering by turning the handlebars and acceleration and stopping by hand controls. Powertrain 106 is mechanically coupled to at least one of wheels 101 and 102 and may be comprised of an electric motor or gas engine with along with any transmission necessary to power the motorized scooter. In some embodiments where the powertrain uses electric energy, a charging port 107 may be located on upright support 104. Electronics housing 108 may also be located within the body of upright support 104. In various embodiments, the location of any components may be different. For example, in some embodiments, charging port 107 or electronics housing 108 may be located on or under deck 103.

Electronics housing 108 houses electronics and other associated systems or devices. In some embodiments, electronics housing 108 houses a computing platform including a processor and a memory, a location determination module, and a plurality of wireless communications interfaces. For example, a computing platform may comprise a “system on a chip” that integrates all components of a computer system in one compact form factor. A location determination module may be, for example, a module capable of determining location based on one or more of Global Positioning System (GPS), Differential GPS, GALILEO, GLONASS, or other such radionavigation-satellite services.

Wireless communications interfaces may include one or more wireless local area network interfaces, wireless personal area networks interfaces, wireless wide area network interfaces, wireless metropolitan area network interfaces, and/or cellular network interfaces. Wireless local area network interfaces may include interfaces compatible with any wireless local area network technology such as but not limited to IEEE 802.11 (i.e., Wi-Fi). Wireless personal area network interfaces may include interfaces compatible with any wireless personal area network technology such as but not limited to Bluetooth, ZigBee, Z-Wave, Wireless USB, and/or IrDA. Wireless metropolitan area network interfaces may include interfaces compatible with any wireless metropolitan area network technology such as but not limited to IEEE 802.16 (i.e., WiMAX). Wireless wide area network interfaces may include interfaces compatible with any wireless wide area network technology such as but not limited to LoRaWAN (Long Range Wide Area Network). Cellular network interfaces may include interfaces compatible with any cellular network technology such as but not limited to Global System for Mobile Communications (GSM), General Packet Radio Service (GPRS), Long-Term Evolution (LTE), cdmaOne, CDMA2000, Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/TDMA), and/or Integrated Digital Enhanced Network (iDEN).

Electronics housing 108 may also include one or more sensors disposed within or near electronics housing 108 such as but not limited to light sensors, temperature sensors, force sensors, color sensors, imaging sensors, acoustic or sound sensors, vibration sensors, magnetic sensors, electric current sensors, humidity sensors, position sensors, compasses, acceleration sensors, orientation sensors, or other similar sensors.

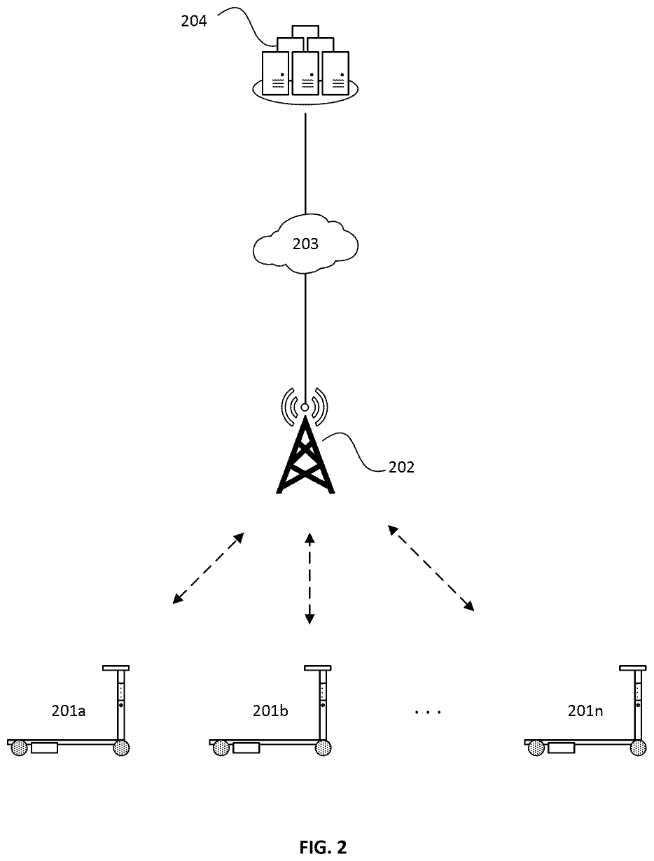

A scooter may communicate with a remote computing platform via one or more of the on board wireless network interfaces. FIG. 2 illustrates an example wireless communication environment in which several scooters communicate with a central computing platform. In FIG. 2, scooters 201a-n are in wireless communication with wireless base station 202. Wireless base station 202 is connected via network 203 to network resources 204. In an example, the scooter may report location information to a remote computing platform to enable an operator to track the location of the scooter. When a scooter determines to send a message, it may select one of the wireless interfaces available to send the message. For example, a scooter with both a cellular network interface and a wireless WAN network interface may choose which of those two interfaces to use for any particular message. In some embodiments, the controller may store and maintain various statistics or pieces of information about each wireless network interface available to it to aid in selecting a wireless interface for any particular message. For example, a controller may record latency and throughput statistics on a continual or periodic basis to estimate a link quality or reliability for each wireless network interface. The controller may also receive some of this information from querying the wireless network interface directly, such as signal strength (e.g., received signal strength indicator (RSSI)) or a signal-to-noise (SNR) ratio for a given wireless network interface. In addition, the controller may receive pricing information from an operator of the scooter system. In some embodiments, the pricing information may be received as a representation of price per unit of communication, such as time or quantity of information. In some embodiments, the pricing information may be received as a relative ranking of all wireless network interfaces available to the controller. In some embodiments, pricing information may include not only monetary pricing, but also power expense. For example, a particular wireless network interface may consume lots of power, while another may be suitable for low-power operation.

In some embodiments, messages may be tagged or marked with an importance indicator and an optional timeout indicator. Messages may be ranked on a relative scale of importance, such as an integer from 0 to 100, or a more course representation such as low priority, medium priority, and high priority. A timeout may be expressed as either a duration of time measured from the controller receiving the message or as a set absolute time by which the message will timeout. A timeout may also be infinite such that the timeout never expires for some messages. In operation, some messages may be tried and retried several times based on retry criteria before the timeout period expires. Some messages may be escalated to a different wireless network interface before the timeout expires. Some messages may be dropped upon timeout expiration, and other messages may be escalated to a different wireless network interface upon timeout expiration.

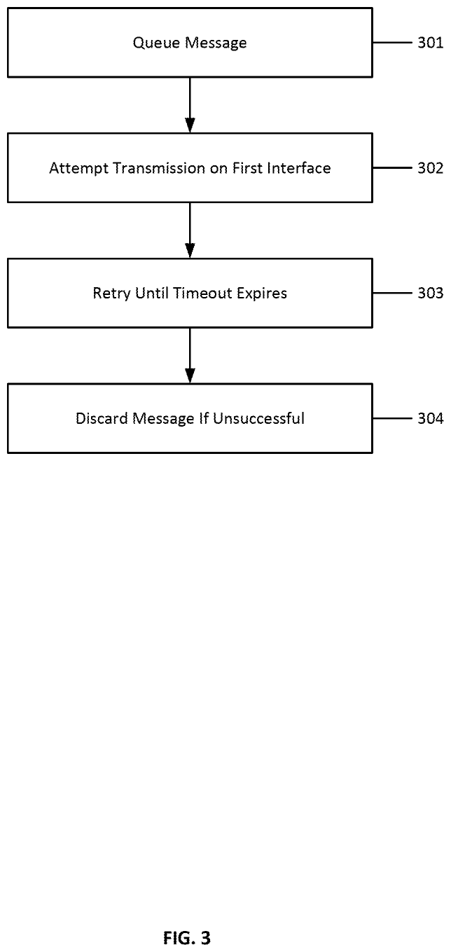

FIG. 3 illustrates the steps of a method of processing a low priority message. In this example, a routine status message is queued at step 301 that is marked with a low priority, and a relatively long timeout of 30 minutes, and marked to drop the message upon timeout. Within the 30 minute timeout window, the controller will, at step 302, attempt to transmit the low-priority status message with the least expensive interface available, whether in monetary terms or power budget terms. This may include waiting for the scooter to move to a new location where a low expense network interface attains a connection. For example, a Wi-Fi network interface may not have network connectivity when the message is first queued for transmission, but within the timeout window the scooter is transported to a location where the Wi-Fi network interface attains a signal and is able to transmit the message. The scooter will attempt to retry sending the message at step 303 until the timeout expires. If the message is not transmitted within the timeout window, at step 304 it is dequeued and not transmitted because the message was marked to drop upon failure.

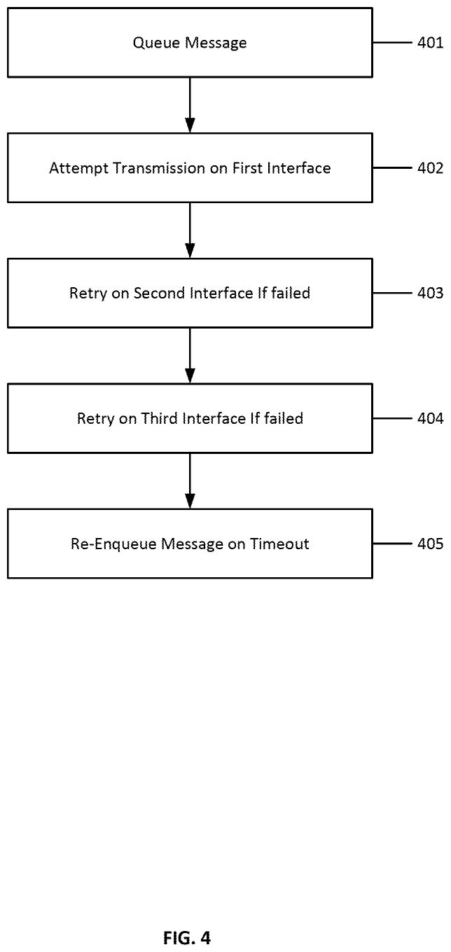

FIG. 4 illustrates the steps of a method of processing a medium priority message. A medium-priority message is enqueued at step 401 with a medium priority and configured to escalate upon failure. For example, the controller may first attempt to transmit the message on a first wireless network interface at step 402, and in the event of failure, retry again but with a different wireless network interface at step 403, repeating as necessary. For example, a third interface may be tried at step 404. This may include, for example, first attempting to transmit the message on Wi-Fi connection, but if that fails, retrying using a cellular modem. If the message timeout expires, it may be requeued at a different priority level at step 405.

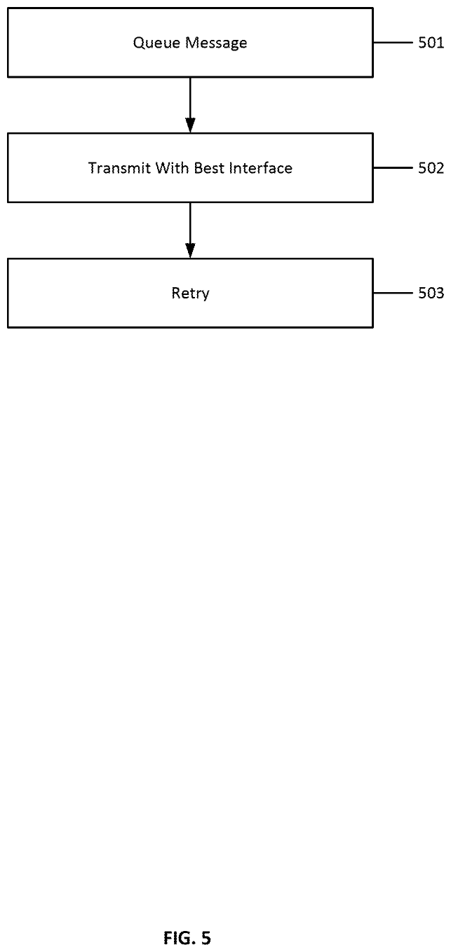

FIG. 5 illustrates the steps of a method of processing a critical priority message. A critical-priority message is enqueued at step 501 marked with a critical priority, and an infinite timeout. This high priority message will be scheduled at step 502 to be transmitted on the best or otherwise most reliable network interface available regardless of cost. In some embodiments, a message may be transmitted on multiple interfaces at the same time in parallel. If initial transmission fails, the controller will retry continuously at step 503, with the possibility that the wireless environment around the scooter changes and a wireless network interface is able to connect and transmit the message.

In general, messages may be marked with any combination of properties to produce the desired balance between the cost of transmitting the message and the relative importance that the message be transmitted within a given timeout window. Any combination of any portion of the above examples may be mixed to produce a desired result in a given application.

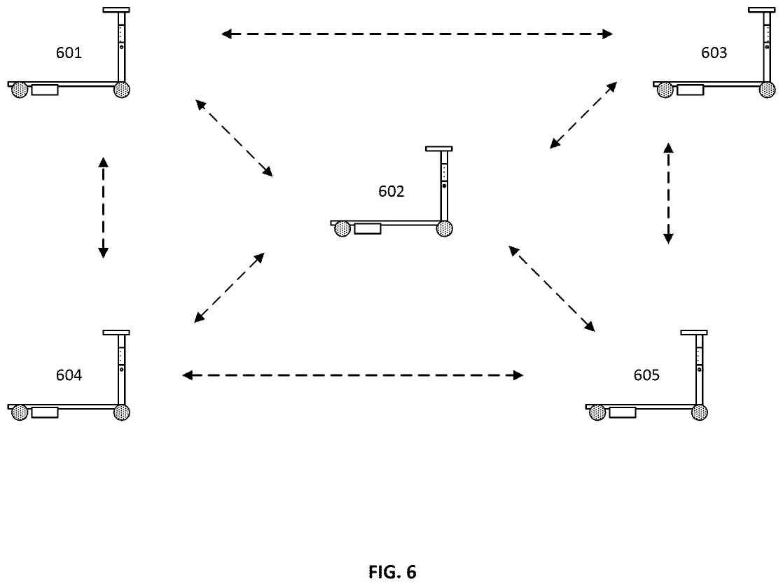

In some embodiments, one or more of the wireless network interfaces may cooperate with other like network interfaces one other scooters to form a mesh network. FIG. 6 illustrates an example mesh networking environment according to an embodiment. For example, a Wi-Fi network interface of a scooter may be configured to form a mesh network with other Wi-Fi network interfaces on other scooters 601-605 in proximity. One or more scooters may also act as a bridge between the mesh network and any other external network. For example, a chain of scooters may relay a message along a mesh network and then a scooter with a reliable cellular network connection may relay that message to a computing resource on the Internet, while the originating scooter may not have been able to do so itself.

A scooter may use its array of wireless network interfaces for location determination. For example, radio triangulation may be used based on received signals to estimate a location relative to other radio signals. In the event that the received radio signals are identifiable and associated with a known location, the scooter controller may be able to estimate its current position based on received signal strength indicators. Similarly, a scooter may broadcast a beacon message on one or more network interfaces to enable other receiving radios to estimate the scooter's location using one or more receiving stations. In some embodiments, a scooter may periodically relay a snapshot of all of the radio signals that it can observe on all of its available wireless network interfaces to a centralized computing platform which may combine the aggregate information and determine estimates for each reporting scooter. In addition, external services or databased may be queried for additional locating information. For example, a Wi-Fi location database may be used to determine a scooter's position with a Wi-Fi positioning system (WPS). In some embodiments, a charging dock may include similar computing and wireless communications capabilities and hardware as a scooter, adding additional radio nodes with known fixed locations that may be used for wireless location determination. For example, in some embodiments, a Bluetooth interface on a scooter may broadcast a beacon signal and a charging dock with a fixed location may listen for the beacon signal. When the scooter is in proximity to the charging dock, a received signal strength or time-of-flight based distance estimate may provide a location estimation of the scooter. Similarly, the charging dock may broadcast a Bluetooth beacon signal of its own that the scooter listens for. Then, the scooter may estimate its own position based on a range estimation of the identified charging dock that has a known fixed location. In some embodiments, scooter operators having other wireless communication devices may also provide additional radio nodes from which to estimate location. For example, an operator of a scooter may carry a smartphone device on their person which includes a Bluetooth interface which can operate as both a beacon and a receiver for other beacons. Software running on the smartphone may relay range estimates to the central platform that indicate proximity estimates for scooters and charging docks that add further data points to the overall location estimation.

The scooter controller may detect intrusion attempts into the scooter. In some embodiments, the controller may detect attempts to open electronics housing 108 that are not authorized. While the housing 108 may be locked and secured by physical means such as a key lock, thieves may attempt to forcibly open the housing to retrieve one or more components therein. For example, lithium-ion batteries may be valuable targets for potential thieves. The scooter controller may be programmed to detect certain conditions that may indicate whether or not an attempted intrusion is malicious or not.

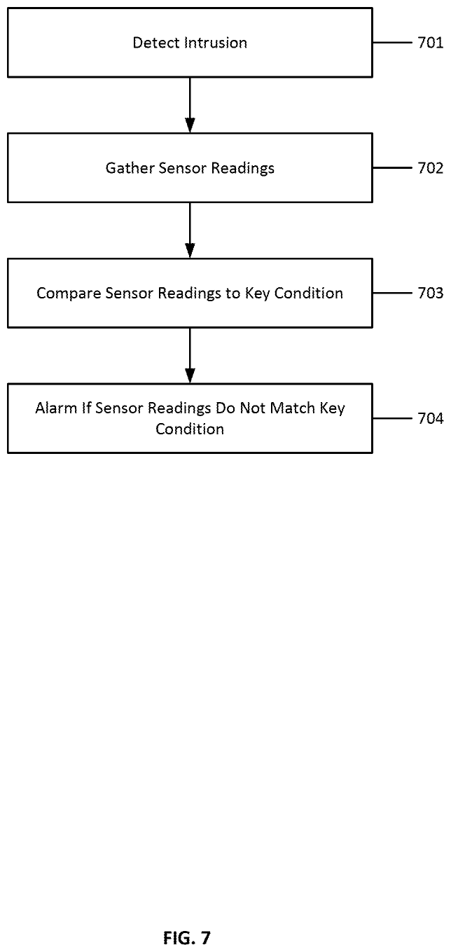

FIG. 7 illustrates the steps of a method for detecting malicious intrusion according to an embodiment. In this example, a particular pattern, or fingerprint, of sensor readings may be a “virtual key” which signals to the controller whether an access is authorized or not. At step 701, an intrusion into the housing of a scooter is detected. At step 702, sensor readings are gathered from various sensors disposed within and around the scooter and housing. In an example, a combination of sensor values such as temperature and direction heading may be such a key. The sensor readings are compared against a known pattern of sensor readings at step 703. If an attempt to open the housing 108 is detected concurrently with condition that do not meet a predefined key condition, the access may be unauthorized and an alarm condition set at step 704. Authorized individuals who know the key condition can satisfy the key condition to signal to the controller that access is authorized. In this example, a key condition may be that the scooter is facing south, and the temperature is under 60 degrees. Then, authorized individuals may face the scooter south and lower the temperature in the work environment to satisfy the key condition, signaling that their access attempt is authorized. If an intruder attempts to open the housing when the scooter is facing westward and the temperature is 90 degrees, the scooter controller may infer that the intrusion is malicious and respond accordingly.

Any combination of sensors and parameters may be combined to form a key condition, including any condition sensed from any sensors of the scooter as well as location estimates and radio signal environment information. For example, a particular area may be designated as a maintenance area, and any access to the scooter's housing outside of that area may be unauthorized. This area-bounding may be referred to as geofencing. Similarly, presence of a particular Bluetooth beacon or other wireless radio beacon may signal an unauthorized access condition.

Similarly, a scooter controller may detect theft of the scooter. A scooter is a portable device and may be stolen in whole rather than tampered with in the field. In some embodiments, the scooter controller may monitor location and speed information from positioning sensors to detect conditions indicative of theft. For example, a scooter may be geofenced to a particular city or locale and transport outside of that area may be an indication of theft. Similarly, if a scooter detects its rate of speed exceeds the speed it is capable of under its own power, that may indicate that the scooter has been placed in another vehicle which may also signal a theft condition. Anomalies in network connectivity or radio frequency environment may signal a theft condition. For example, a sustained and complete lack of any received wireless communication signals may indicate that the scooter has been placed in an environment designed to disrupt communications intentionally, such as a Faraday cage. Similarly, a scooter may detect presence of many other scooters in close proximity as an indication of theft as it may indicate that a large number of scooters have been grouped together for transport. In some embodiments, any combination of these features may comprise a condition to determine if the scooter has been stolen.

When an unauthorized access or theft is detected, the scooter controller may respond accordingly. In some embodiments, a response to unauthorized intrusion may include transmitting a message to a management platform indicating the scooter may be under threat. In some embodiments, the scooter controller may respond by active measures, such as disabling or damaging components of the scooter to render them valueless to a would-be intruder. For example, a battery may be intentionally disabled to render it inoperable and therefore undesirable to steal. Similarly, various components may be intentionally subject to large currents or high voltages to safely render them inoperable in response to detecting intrusion.

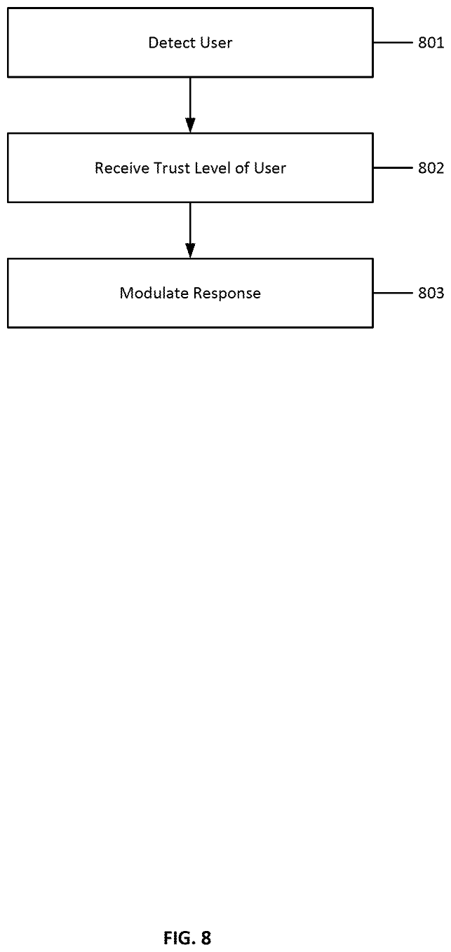

Responses to both theft and intrusion may be modulated based on a trust factor of an associated user. FIG. 8 illustrates the steps of a method to module a response to an intrusion or theft according to an embodiment. At step 801, a known user is identified, and at step 802 a trust level of that user received. For example, if a user has rented the scooter and is in close proximity to it, a trust factor associated with that user may modulate the theft and intrusion response. At step 803, the scooter's response to the intrusion or theft condition is modulated by the identified user's trust level. While detecting that the scooter is travelling in a vehicle may be a prima facie indication of theft, the scooter may not respond as severely if it also detects that a trusted user is in close proximity. In this way, the scooter may not take any measures which cause permanent damage in the event that the use is not malicious, even if perhaps outside of the confines of normal usage. In some embodiments, a user need not be associated with the scooter. For example, proximity alone of a known user may be used to modulate the scooter's response to detected conditions.

In some embodiments, a scooter charging dock may be hosted by a business. Information about the benefits of hosting a charging dock may be tracked and provided to the hosting business. Such information may include indirect benefits, such as foot traffic, or direct benefits, such as sales.

In one embodiment, indirect traffic metrics are tracked for a hosting business. Traffic metrics may include the number of rides starting or ending at docks associated with the business, the number of times a business name is viewed by users looking for scooters or charging docks, or an estimated dollar value of user views. Metrics may be aggregated across multiple associated branches for businesses with multiple locations.

In one embodiment, direct benefit metrics are tracked for a hosting business. Riders may be shown offers such as discounts or reservation availability for businesses hosting a dock and are located at the starting point, ending point, or along the route of a ride. Offers may be shown at booking, after return, or during a ride based on location. Offers may be provided on a screen attached to the handlebars of the scooter, provided through the scooter booking app, or provided by other means. Direct benefit metrics may include offer display rates, offer acceptance rates, number of offer acceptances, or dollar value of offer acceptances.

In some embodiments gamification elements may be added to the user interface to incentivize beneficial behavior. Riders may receive points for taking certain actions. Accumulation of a threshold number of points may grant levels or badges. Points may be exchangeable for discounts, displayable through the app or social media, or provide rewards at certain levels. Rewards may include physical rewards such as t-shirt or other swag or digital rewards such as discounts or ride credit.

In one embodiment, points are granted for beneficial behavior related to maintenance such as reporting damage or errors, reporting location of a lost or missing scooter, or returning a scooter to a specified dock or location. In one embodiment, points are granted for beneficial behavior related to increasing accessibility of scooters such as returning a scooter to a dock or photographing or describing a scooter parking location when not returning to a dock. In one embodiment, points are granted for beneficial behavior related to scooter usage, such as frequent rides or consecutive daily rides. In some embodiments, scooter pricing may be dynamically set based on a variety of factors. Pricing may be adjusted prior to a ride or discounted based on triggers during or after a ride. Price reductions may be provided as discounts or as offsetting ride credit toward future rides.

In one embodiment, prices may be adjusted to balance scooter availability across geographic regions. For example, prices may be raised based on high demand or lowered based on low demand in the pickup region. Prices may also be raised or lowered based on likelihood of finding a next rider, rising with low demand or lowering with high demand in the drop off region. Demand may be measured by current active users or user requests or by expected demand based on historical activity.

In one embodiment, prices may be adjusted based on scooter security or risk. For example, prices may be raised for users associated with scooter damage in the past, or lowered for users with longer history of use. Pricing may be lowered for rides ending at a charging dock or for photos of safe parking locations.

In one embodiment, prices may be adjusted based on making maintenance easier. For example, prices may be lowered for scooters returned to a charging dock when low on battery. Prices could also be lowered for scooters returned to charging docks ahead of periods of expected low activity or low visibility such as in the evening or prior to inclement weather. A discount or ride credit may be provided for accurately reporting scooter damage or the location of a lost or missing scooter. In some cases, prices could be negative such that users receive a net refund or ride credit.

In some embodiments, a mobile sensing system may be deployed to determine the location of a scooter when it is unable to self-report location based on GPS. Inability to self-report may be due to GPS malfunction or malfunction of the communication array. In these embodiments, scooters may be equipped to broadcast an identifier over a communications protocol such as Bluetooth or LoRaWAN.

The mobile sensing system may include multiple sensing units which may be land-based or air-based and may be an autonomous drone or mounted on a manually operated vehicle such as a maintenance truck.

In one embodiment, the sensing system would dispatch a sensing unit on demand when a scooter is determined to be missing. This determination may be made based on criteria such as a lack of location update for a period of time, a report of missing scooter from a user, or a scooter indicating it is not able to detect GPS signal. The sensing unit would be dispatched to the last known location of the scooter. An autonomous sensing unit may be dispatched directly to a location or batch of locations to search. A sensing unit mounted on a manually operated vehicle may be dispatched by adding the location to the vehicle's scheduled route. If the missing scooter's signal is detected, multiple measurements may be taken to triangulate the scooter's location. This location would be recorded and flagged for maintenance tasks.

In one embodiment, the sensing system would assign each sensing unit to monitor an area. Routes for autonomous and mounted sensing units may be planned and adjusted to substantially cover the assigned area. Sensing units may be provided a set of scooters determined to be missing per the criteria above. Sensing units may be instructed to passively listen to all scooter signals or to actively search for missing scooters last seen or expected to be in the assigned area. If a missing scooter's signal is detected, multiple measurements may be taken to triangulate the scooter's location. This location would be recorded and flagged for maintenance tasks.

In some embodiments, scooters may be equipped with signal interference capabilities to ensure exclusive use of a communication channel. The communication channel may be a cell band or wavelength. Scooters may be assigned a channel or determine a channel based on rules or heuristics. Scooters may broadcast a fixed interference pattern on the channel, creating noise which saturates the communication channel. Scooters may still operate on the communication channel by filtering the fixed interference pattern while preventing use of the channel by other units which do not know the interference pattern.

In one embodiment, scooters consistently broadcast the interference pattern to continuously exclude use of the assigned channel.

In one embodiment, scooters only broadcast the interference pattern when detecting use of the assigned channel by an unknown system. Detection may require a threshold such as a certain length of time or signal strength.

In one embodiment, interference pattern may be broadcast by automated drones rather than attached to the scooters.

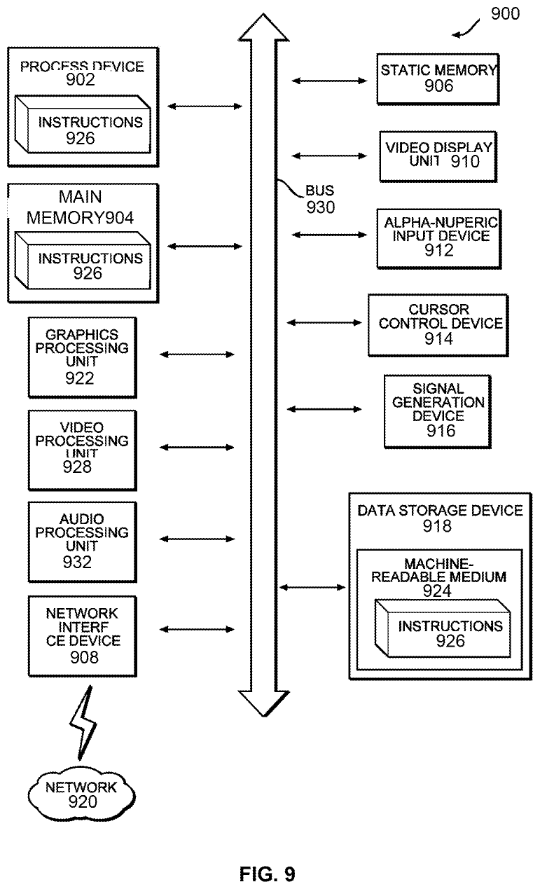

FIG. 9 illustrates an example machine of a computer system within which a set of instructions, for causing the machine to perform any one or more of the methodologies discussed herein, may be executed. In alternative implementations, the machine may be connected (e.g., networked) to other machines in a LAN, an intranet, an extranet, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 900 includes a processing device 902, a main memory 904 (e.g., read-only memory (ROM), flash memory, dynamic random access memory (DRAM) such as synchronous DRAM (SDRAM) or Rambus DRAM (RDRAM), etc.), a static memory 906 (e.g., flash memory, static random access memory (SRAM), etc.), and a data storage device 918, which communicate with each other via a bus 930.

Processing device 902 represents one or more general-purpose processing devices such as a microprocessor, a central processing unit, or the like. More particularly, the processing device may be complex instruction set computing (CISC) microprocessor, reduced instruction set computing (RISC) microprocessor, very long instruction word (VLIW) microprocessor, or processor implementing other instruction sets, or processors implementing a combination of instruction sets. Processing device 902 may also be one or more special-purpose processing devices such as an application specific integrated circuit (ASIC), a field programmable gate array (FPGA), a digital signal processor (DSP), network processor, or the like. The processing device 902 is configured to execute instructions 926 for performing the operations and steps discussed herein.

The computer system 900 may further include a network interface device 908 to communicate over the network 920. The computer system 900 also may include a video display unit 910 (e.g., a liquid crystal display (LCD) or a cathode ray tube (CRT)), an alphanumeric input device 912 (e.g., a keyboard), a cursor control device 915 (e.g., a mouse), a graphics processing unit 922, a signal generation device 916 (e.g., a speaker), graphics processing unit 922, video processing unit 928, and audio processing unit 932.

The data storage device 918 may include a machine-readable storage medium 924 (also known as a computer-readable medium) on which is stored one or more sets of instructions or software 926 embodying any one or more of the methodologies or functions described herein. The instructions 926 may also reside, completely or at least partially, within the main memory 904 and/or within the processing device 902 during execution thereof by the computer system 900, the main memory 904 and the processing device 902 also constituting machine-readable storage media.

In one implementation, the instructions 926 include instructions to implement functionality corresponding to the components of a device to perform the disclosure herein. While the machine-readable storage medium 924 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying” or “determining” or “executing” or “performing” or “collecting” or “creating” or “sending” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

Various general purpose systems may be used with programs in accordance with the teachings herein, or it may prove convenient to construct a more specialized apparatus to perform the method. The structure for a variety of these systems will appear as set forth in the description below. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

A number of embodiments have been described. Nevertheless, it will be understood that various modifications may be made without departing from the spirit and scope of the invention. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

What is claimed is:

1. A method of detecting intrusion into a scooter, comprising:
receiving an indication that a compartment of a scooter is being accessed;
receiving an identification of a user associated with the scooter in proximity to the scooter;
receiving a plurality of sensor readings from a respective plurality of sensors disposed within the scooter;
comparing the plurality of sensor readings to a sensor fingerprint;
based on the comparing, determining that a difference between the plurality of sensor readings and the sensor fingerprint exceeds a threshold difference; and
in response to the determining, transmitting an alarm message to an alarm, wherein in response to receiving the alarm message, the alarm enters an alarm state.

2. The method of claim 1, wherein the plurality of sensors includes a location sensor.

3. The method of claim 1, wherein the sensor fingerprint is comprised of a plurality of sensor threshold values corresponding to the plurality of sensors.

4. The method of claim 3, wherein the comparing the plurality of sensor readings to a sensor fingerprint comprises comparing each of the plurality of sensor threshold values to a corresponding sensor reading for a corresponding sensor.

5. The method of claim 1, wherein the alarm message is transmitted via two different wireless communication systems in parallel.

6. The method of claim 1, wherein the alarm transmits the alarm message to a central alarm monitoring station in response to receiving the alarm message.

7. The method of claim 1, wherein the alarm disables one or more devices or systems of the scooter in response to receiving the alarm message.

8. A method of detecting portable personal vehicle theft, comprising:
determining a first location of a first personal vehicle;
determining a first speed of the first personal vehicle;
determining a second location of a first personal vehicle;
determining a second speed of the first personal vehicle;
comparing the first location to the second location;
comparing the first speed to the second speed;
determining that the first location is within a threshold proximity to the second location;
determining that the first speed is within a threshold proximity to the second speed; and
in response to determining that the first location is within a threshold proximity to the second location and determining that the first speed is within a threshold proximity to the second speed, transmitting an alarm message.

9. The method of claim 8, wherein the first location is determined by a GPS module.

10. The method of claim 8, wherein the first location is determined by detecting a Bluetooth beacon in proximity to the first personal vehicle.

11. The method of claim 10, wherein the Bluetooth beacon is disposed within the second personal vehicle.

12. The method of claim 8, further comprising:
determining that the first speed is above a threshold speed corresponding to a maximum speed that the first personal vehicle can travel under its own power.

13. The method of claim 8, wherein the alarm message is transmitted by two independent wireless communications systems at the same time.

14. A motorized scooter, comprising:
a deck;
two wheels;
a motor;
a transmission mechanically coupling the motor to one of the two wheels; and
an electronic housing enclosing a computing platform, one or more wireless communication modules, and one or more sensors,
wherein the computing platform is configured to detect a security condition detected by the one or more sensors and transmit an alarm message via the one or more wireless communication modules.

15. The motorized scooter of claim 14, further comprising a satellite positioning module.

16. The motorized scooter of claim 14, wherein the motor is an electric motor, and the electronic housing encloses an electric battery.

17. The motorized scooter of claim 14, wherein the one or more sensors includes an acceleration sensor.

18. The motorized scooter of claim 14, wherein the one or more wireless communication modules includes a LoRaWAN communication module.

19. The motorized scooter of claim 14, wherein the one or more wireless communication modules includes a cellular communications module.

20. The motorized scooter of claim 14, wherein the alarm condition is an indication of theft of the motorized scooter.
